(19) United States
(12) Patent Application Publication
(10) Pub. No.: US 2004/0160981 A1
(43) Pub. Date: Aug. 19, 2004

(54) Hardware service provider

(76) Inventor: Michael Sanders, The Sea Ranch, CA (US)

Correspondence Address: Fay Kaplun & Marcin, LLP, Suite 702, 150 Broadway, New York, NY, 10038, US

(21) Appl. No.: 10/370,176

(22) Filed: Feb. 19, 2003

(51) Int. Cl. H04M 7/00; H04J 15/00

(52) U.S. Cl. 370/464; 379/219

(57) ABSTRACT

An interface connecting an hardware service provider with a media gateway software component is described. The interface facilitate exchange of data within a media gateway unit by removing the requirement that the MEGACO stack of the software component be able to communicate with a variety of gateway HSP's which may operate using different protocols. Messages between the interface and the HSP are exchanged as primitives, using the services of a delivery agent. A client-service relationship is thus set up between the HSP and MEGACO stack.

### BACKGROUND INFORMATION

The public switched telephone network (“PSTN”) encompasses the world's collection of interconnected voice-oriented public telephone networks. The PSTN is an aggregation of circuit switching telephone networks which route phone calls between consumers. Today, the PSTN includes almost entirely digital technology, but some analog remnants remain (e.g., the final link from a central office to the user). The transmission and routing of calls via the PSTN is governed by a set of standards so that various providers of telephone service may easily route calls between their customers. Thus, a first consumer having telephone service A is able to call a second consumer having telephone service B, and the routing of such a call may go through networks owned by various other telephone services C-E. The result is the appearance of a seamless transmission between the first and second consumers.

As an alternative to using standard telephones on the PSTN, consumers may also use their personal computers (“PCs”) to make phone calls to other PC users. The transmission of a call via a PC may be accomplished Voice over Internet Protocol (“VoIP”) technology. VoIP is a set of facilities for managing the delivery of voice information using the Internet Protocol. These PC to PC phone calls are transmitted via the Internet. However, in some instances, a consumer on a standard telephone (attached to the PSTN) desires to call a consumer using a PC phone (attached to the Internet), or vice versa. Thus, standards have been developed to effectively route these types of phone calls between the PSTN and VoIP networks.

A variety of protocols are used to handle telephone calls made to and from Internet-connected PC's, such as the MEGACO standard by the Internet Engineering Task Force (IETF), the Media Gateway Control Protocol (MGCP) and the Session Initiation Protocol (SIP). These protocols seek to bridge the gap between circuit based public switched networks and Internet Protocol (IP) based networks. Each of the protocols uses different conventions and has different sets of function calls and variables, which generally require an interface tailor-made for the specific protocol to communicate with the network transport layer. On the other hand, many different protocols also exist at the transport layer level, where the calls are further formatted for transmission to the Internet. The User Datagram Protocol (UDP), Stream Control Transmission Protocol (SCTP) and the Transmission Control Protocol (TCP) are three such protocols. Access to each protocol also requires an interface that is specific to that protocol.

Media Gateway units (MG's) are the elements that physically connect computer network elements of the telephone system with the conventional telephone network elements (PSTN), to provide the VoIP capability. The primary function of the MG unit is to provide hardware services, and thus typically may include codecs, compression devices (DSP's), tone generation and detection functions, line terminations such as T1, ISDN, POTS and ATM VC's, etc. The system gateway application implemented on the MG is referred to as the hardware service provider (HSP). The media gateway unit also includes a media gateway software component, which carries out media protocol gateway functions not implemented in the HSP.

### SUMMARY OF THE INVENTION

In one exemplary embodiment, the present invention is a system that includes a hardware service provider of a media gateway unit, a media gateway software component of the media gateway unit, and a program interface element configured to form a connection between the hardware service provider and the MEGACO software component, and to aid exchange of data through the connection.

In another exemplary embodiment, the invention is a method of interfacing a media gateway software element with a hardware service provider. The steps include sending from a program interface element of the media gateway software element a client add function, the client add function requesting a binding with the hardware service provider, and receiving in the program interface element a signal indicating acceptance or rejection of the binding. When the acceptance signal is received, the method includes exchanging primitives between the program interface element and the hardware service provider.

### BRIEF DESCRIPTION OF THE DRAWINGS

FIG. 1 is a diagram showing an exemplary telephone to internet connection according to embodiments of the present invention;

FIG. 2 is a diagram showing an embodiment of elements forming a MEGACO software component according to exemplary embodiments of the present invention;

FIG. 3 is a schematic diagram showing an exemplary client-service binding in a media gateway according to the present invention;

FIG. 4 is a schematic diagram showing the message flow between a client and a service in a media gateway according to the present invention;

FIG. 5 is a flow chart showing an exemplary process for exchanging primitives across an HSP interface according to the present invention; and

FIG. 6 is a diagram showing the message flow within the HSP interface according to an embodiment of the present invention.

### DETAILED DESCRIPTION

The present invention may be further understood with reference to the following description of preferred exemplary embodiments and the related appended drawings, wherein like elements are provided with the same reference numerals. The exemplary embodiments described herein refer to voice communications (e.g., phone calls). However, those of skill in the art will understand that the present invention may be equally applied to systems, networks and/or hardware used for communication of data or other information. Those of skill in the art will also understand the basic concepts of the transmission of voice and/or data information across network devices. Those who desire a more detailed discussion of network data transfer may consult a reference such as, Perlman, Radia “Interconnections Second Edition—Bridges, Routers, Switches, and Internetworking Protocols,” Addison Wesley, 2000.

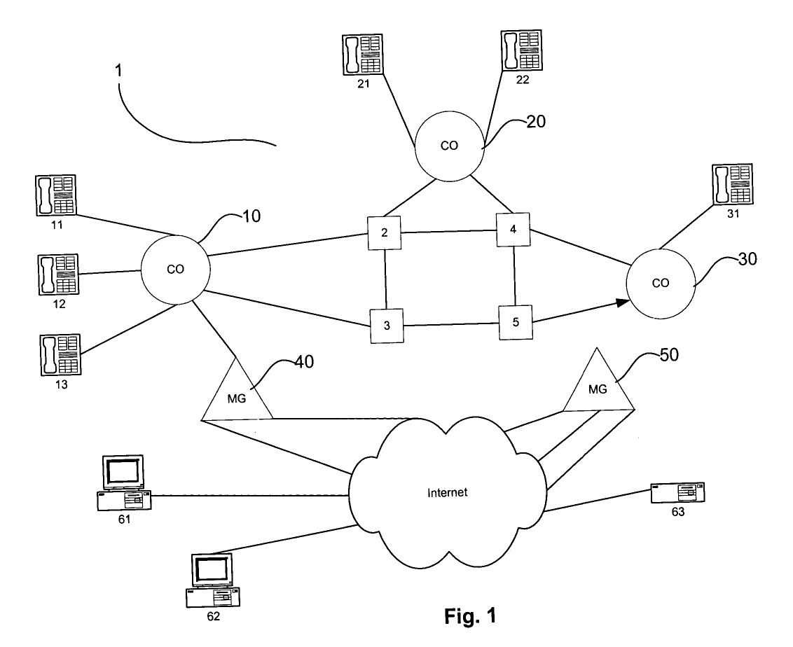

FIG. 1 shows an exemplary network arrangement 1 for the connection of voice communications. The network arrangement 1 includes three central offices (“CO”) 10, 20 and 30 which are locations where telephone companies terminate customer lines and locate switching equipment to interconnect those lines with other networks. In this example, the customer lines 11-13 terminate at the CO 10, the customer lines 21-22 terminate at the CO 20 and the customer line 31 terminates at the CO 30. The customer lines may be any type of lines, for example, plain old telephone service (“POTS”) lines, integrated services digital network (“ISDN”) lines, frame relay (“FR”) lines, etc. In this example, each of the customer lines (e.g., customer line 11) may be considered a POTS line attached to a standard telephone at the customer location.

Between the COs 10, 20 and 30, there may be a series of switching stations 2-5. These switching stations 2-5 direct the calls along a route from a transmitting CO to a receiving CO. For example, a user on the customer line 11 may attempt to call a user at the customer line 31. The call may be transmitted from the customer line 11 to the CO 10, which will then route the call into the system to arrive at the CO 30. When the call is in the system, it may take a variety of routes between the CO 10 and the CO 30 based on various parameters, e.g., system traffic, shortest route, unavailable switches, etc. In this example, the call may be routed from the CO 10 to the switching station 2, through to the switching station 4 and then to the CO 30 which connects the call to the customer line 31. The portion of the network arrangement 1 described above may be considered the PSTN portion of exemplary network arrangement 1.

In addition, there may be a VoIP portion of network arrangement 1. In this example, personal computers (“PC”) 61, 62 are equipped with hardware and software allowing users to make voice phone calls. The PCs 61, 62 have connections to the Internet 60 for the transmission of the voice data for the phone calls made by the users. If a PC user makes a voice call to another PC user (e.g., user of PC 61 calls user of PC 62), the call may be routed from the PC 61 through the Internet 60 to the PC 62. However, for calls from the PSTN portion of the network arrangement 1 to the VoIP portion and vice-versa, media gateway units (“MG”) 40, 50 may be used as routers for such calls. Thus, if the user of PC 61 calls the user of customer line 31, the call may be routed from the PC 61 through the Internet 60 to the MG 50, and further to the CO 30 which connects the call to the customer line 31. Those of skill in the art will understand that the previously described components are only exemplary and that there may be other components used to route calls, for example, the VoIP portion of the network may contain a media gateway controller. In addition, PC's 61, 62 may include other computing devices (such as IP phones, personal digital assistants, or other embedded computing devices) with network connection capabilities.

As seen from the examples described above, the phone calls may be routed through the exemplary network arrangement 1 by a variety of hardware devices (e.g., COs, switching stations, MGs, etc.). Standards groups have been set up to promulgate standardized protocols used to route these phone calls through different telephone systems. For example, Signaling System 7 (“SS7”) is a telecommunications protocol defined by the International Telecommunications Union (“ITU”). For a more detailed discussion of SS7 see the following standard publication, “ANSI, T1.110-1992, Signaling System 7 (SS7) General Information, 1992”. Also see the sequence of standards, ANSI, T.1 11-114, related to SS7. In general, the SS7 protocol is implemented on equipment used in the PSTN portion of the network 1 (e.g., CO 10, 20 and 30, switching stations 2-5), and may be used for a variety of features related to phone calls, for example, basic call setup, management, tear down, local number portability, toll-free and toll wireline services, call forwarding, three-way calling, etc.

A protocol standard of particular relevance to the present invention used in the VoIP portion of network arrangement 1 is the MEGACO standard, developed by the Internet Engineering Task Force (“IETF”). For a more detailed discussion of the MEGACO standard see the following publication, “IETF, RFC 3015, MEGACO Protocol Version Standards”. MEGACO defines the protocols used between elements of a physically decomposed multimedia gateway consisting of a MG unit (e.g., MG's 40, 50) and a Media Gateway Controller (MGC) 63, formed by a special purpose computer configured to control MG's 40, 50. The MGC 63 sends instructions to the MG unit, such as instructions on which lines are to be used. Those of skill in the art will understand that the above described protocols are only exemplary and that additional implemented protocols exist, while new protocols may be implemented in the future. The present invention is equally applicable to any of these systems implementing protocols.

Each of the described components in network arrangement 1 may implement a variety of protocols to route calls to the desired location. The described components may include one or more electronic memory devices and processors, or other computing devices, to provide the desired functionality (e.g., routing of the phone calls, etc.). Thus, these components may contain software elements to instruct the processor or other computing device to perform the desired functions and implement the various protocols. The present invention may thus be implemented on any of the above described components, or in any other processor based components used to further the transfer of information through a network.

An exemplary embodiment of the software architecture according to the present invention, is implemented in a media gateway (MG) software component, and is functionally located between a gateway application and a native transport layer of a network connection. For example, the gateway application may be an hardware service provider (HSP), and the native transport layer may include UDP, TCP, etc. The MEGACO software component's architecture includes several elements, such as a core module, an HSP API interface, an encode-decode library and other data transfer elements. Operating system and management services may be provided by a system management entity (SME) and a system library (SYSLIB), as well as by delivery agents (DA's). The MEGACO software component, together with the HSP, forms the media gateway unit 40, 50 shown in FIG. 1, used to connect the PSTN and the VoIP portions of the network 1.

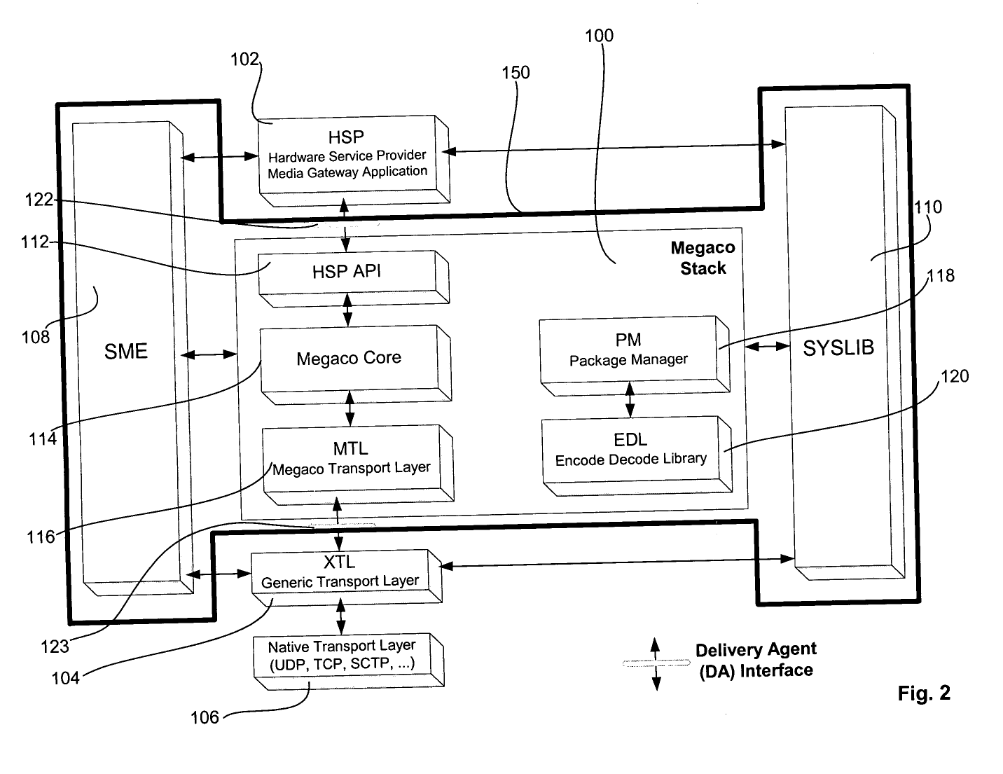

FIG. 2 shows one exemplary implementation of a MEGACO software component 150 according to the present invention. MEGACO stack 100 forms the principal element of the MEGACO software component 150, and is used as an intermediary between an HSP 102 module and an XTL 104 generic transport layer module. HSP 102 is a media gateway application that has the primary function to provide hardware services. It may include codecs, compression devices, tone generation and detection functions and line terminations. As indicated above, HSP 102 may include both hardware elements and software elements adapted to carry out its functions. HSP 102 is supplied by the gateway system developer, and may vary based on the developer's preferences. XTL 104 is a generic transport layer that serves as an abstraction to the underlying native transport layer 106. XTL 104 provides a protocol-independent transport interface that supports in a uniform manner multiple underlying transport networks, such as IP, ATM, UDP, TCP and other future or already existent transport protocols. XTL 104 includes an interface that handles protocols in an uniform and generic manner, to remove the requirement of any knowledge specific to the underlying transport layer from the MEGACO stack 100. For example, XTL 104 may be the XTL described in U.S. patent application Ser. No. 10/252,989, entitled “Generic Transport Layer,” filed on Sep. 23, 2002, which is expressly incorporated by reference herein.

MEGACO stack 100 may include a core module 114 connected to HSP 102 via an interface. Core module 114 maintains a list of the terminations supported by the media gateway and a list of contexts created by the media gateway controller, and also executes the commands issued by the MGC. Multiple commands may be contained within a single transaction processed by core module 114. A list of commands is received in a single transaction from MEGACO transport layer (MTL) 116, which provides for the reliable transport of messages of the stack 100, and provides an “at most once” functionality and retransmission of requests and responses. Core module 114 then executes the commands one by one, for example in the sequence given in the list. The responses to the commands may be written to a buffer, for later use. Depending on the command being executed, the core module 114 may create new contexts, modify existing contexts, and add or remove terminations from a context. In addition, core module 114 may send messages to the HSP 102 through HSP API 112, which instruct the gateway applications associated with HSP 102 to perform various functions. The instructions sent by core module 114 may include instructions to connect two or more media flows to terminations, apply a signal to a termination, or to receive an event that has occurred on a termination. The instructions may also include commands to retrieve statistics on a termination, and to process notifications on whether an occurred event has been requested by the MGC.

As seen in FIG. 2, an encode/decode library EDL 120 may also be a part of MEGACO stack 100. EDL 120 is a library of functions which are used to encode and decode the messages sent through the system. Using EDL 120, text based messages may be converted to data structures and vice-versa. For example, messages received from the network may be text based messages. However, it may be simpler to work with data structures rather than with text messages within the code of MEGACO stack 100. In that case, EDL 120 may be used to convert the text based messages to data structures. Similarly, when messages are sent to the network, the encode library EDL 120 may be used to convert the data structures of MEGACO stack 100 into text based messages.

In one exemplary embodiment according to the present invention, the protocol used in the MEGACO stack 100 uses packages as the designated means of extension to support different services and media types. For example, a package may consist of properties, events, signals and statistics. A termination utilizes a set of such packages. A package manager 118 may be used within MEGACO stack 100 to handle this functionality. During operation, when the MEGACO stack 100 has knowledge that a particular package is supported by the system, implicitly it also has unambiguous knowledge of the properties of the corresponding termination. The use of packages thus provides an interoperable way for extending the capability for information exchange between the media gateway and the media gateway controller, with minimal increase of overhead within the network.

FIG. 2 depicts a systems management entity (SME) 108 that is connected to the MEGACO stack 100. SME 108 is the entity that separates the system-dependent configurations and management functions from the MEGACO stack 100, and acts as a repository for the objects handled by MEGACO stack 100. SME 108 may also perform initialization and coordination of the different modules within MEGACO stack 100. In one exemplary embodiment, SME 108 may include separate modules to provide initialization and administration functions that are unique to MEGACO stack 100. In addition, the core SME 108 may provide access to SME services and to stored configuration and initialization information. SME 108 may also provide notifications of when specific management events occur, for example using specific callback functions.

A systems interface library (SYSLIB) 110 may be used to provide an abstraction layer to the operating system, for example to handle timers, buffers etc. SYSLIB 110 is used to hide the specifics of the operating system from the MEGACO stack 100, such that porting the MEGACO stack 100 to various operating systems simply involves porting the abstraction layer of SYSLIB 110. No specific changes to the protocol stacks themselves are required to complete the porting. The interfaces to SYSLIB 110 and SME 108 will be described in greater detail below.

As indicated above, a complete media gateway unit 40, 50 is formed by a combination of the MEGACO software component 150 and the HSP 102, which typically includes various modules provided by the customer. HSP 102 includes hardware and software elements that operate using any protocols and convention the customer prefers. The MEGACO software component 150 includes the MEGACO stack 100 and the associated services and libraries, such as SME 108 and Syslib 110, as described above. The connection between these two portions of the MG unit 40, 50 may be defined by an interface element that allows HSP 102 to exchange information seamlessly with MEGACO stack 100. For example, in embodiments of the present invention HSP API 112 may perform that function. More specifically, HSP API 112 may provide an interface for registering with the HSP 102, an interface for signals, events, statistics and properties, and an interface for creating and deleting terminations.

HSP API 112 is a programming interface that uses the services of HSP 102 within the MG component 150. HSP API 112 works by connecting with the various gateway hardware control interfaces of the services provided by HSP 102. Accordingly, those hardware control interfaces should be developed by gateway vendors to match the requirements of HSP API 112, to enable the connection. All messages between HSP 102 and HSP API 112 are exchanged in the form of “primitives”, using the services of a delivery agent 122. Primitives are basic messages, which follow a standard necessary to conduct the information exchange between functional layers. The primitives' syntax may include a prefix (e.g. HSP) which designates the boundary crossed by the primitive, a middle term (e.g. SIGNAL) indicating the general class of service being conveyed, such as signal data, and a terminator (e.g. REQ or IND). REQ implies a request, and implies a direction of transmission from client to service. IND implies an indication and is directed from the service to the client. Primitives may be sent with data structures that include the primitive ID and other parameters designating the context and the termination being referenced.

A delivery agent (DA) 122 provides a portable mechanism that different protocol modules may use to exchange primitives and to bind with each other. Internally the DA 122 may use either a function-call interface or a message-based interface. The internal workings of DA 122 are transparent to the binding layers. In addition, DA 122 may also support timer and signal delivery functions. Primitives may be sent and received by HSP API 112 through DA 122 as arguments of primitive transfer functions. For example, separate primitive send and primitive receive functions may be used by HSP API 112 to exchange primitives with HSP 102. The primitive send functions may specify an identifier for the binding with the requesting client, the primitive type, and a pointer to a buffer having primitive information. Similarly, the primitive receive functions may specify the binding identifier, the primitive type indicator, and a pointer to a primitive information data buffer. An additional DA 123 may also be provided to exchange primitives between MEGACO stack 100 and XTL 104. Additional details of DA's may be found in U.S. patent application Ser. No. 10/136,768, entitled “System and method for creating a communication connection,” filed on Apr. 30, 2002, which is expressly incorporated by reference herein.

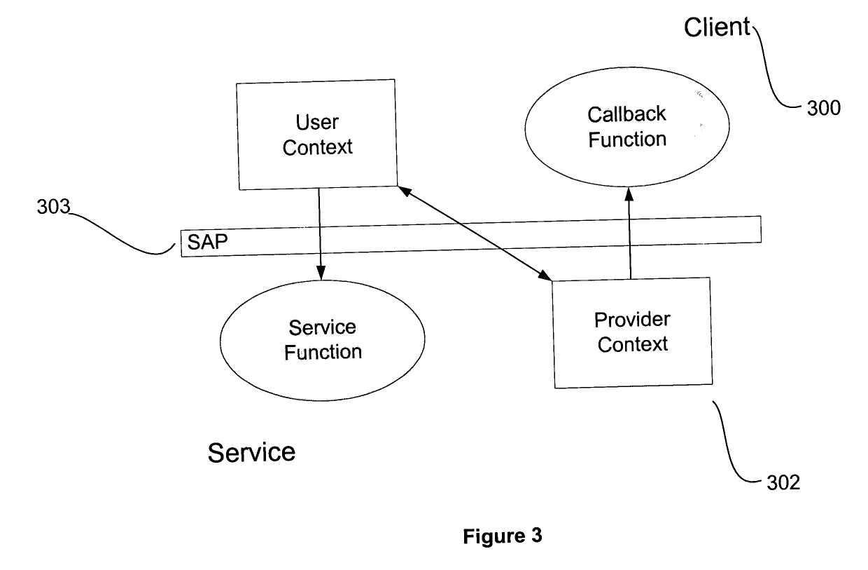

In an exemplary embodiment according to the invention, the relationship between HSP 102 and the MEGACO stack 100 is one of service and client. FIG. 3 shows a diagram of this exemplary relationship between a client 300, such as MEGACO stack 100, and a service provider 302, such as HSP 102. This client-service relationship comprises a documented set of services and interface primitives. In general, any component that requests the services of a second component must adhere to the interface requirements of the second component. When a client 300 wants to use the services of a service 302 component, client 300 must first register with the appropriate DA 122, and must form a binding with the service 302. In this example the binding is represented by a service access point (SAP) 303.

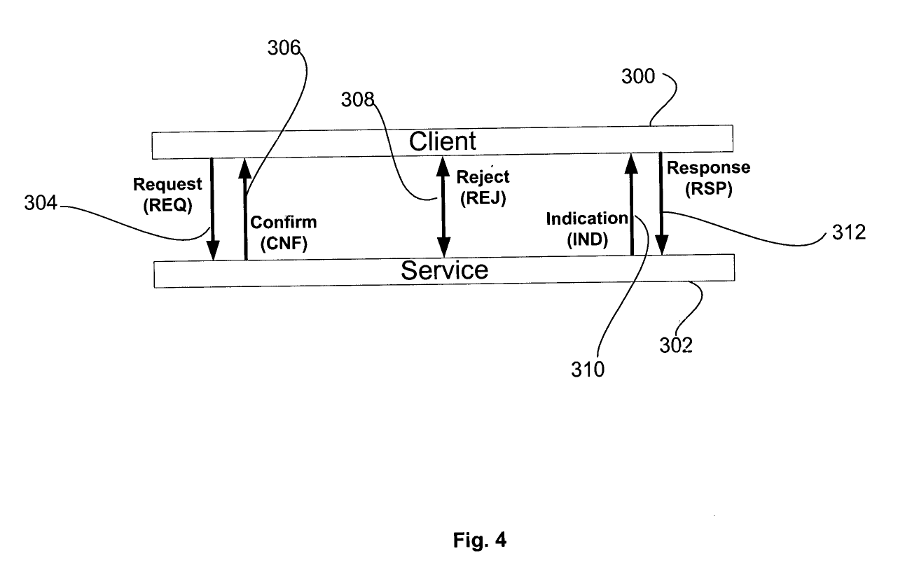

As described above, the messages exchanged through DA 122 between a service 302 and its client 300 are called primitives. FIG. 4 shows a diagram of several types of primitives and messages that may be exchanged. The process may be initiated by the client 300, which sends a request (REQ) 304 to service 302 to initiate some service action. A confirmation (CNF) 306 is then sent from service 302 to client 300, to confirm reception and provide a reply to request 304. An indication (IND) 310 may be sent by the service 302 to client 300, to indicate some activity at the service layer. For example, indication 310 may notify the client 300 of a request from a remote user. Responses (RSP) 312 are made by the client 300 to service 302, and are only made in reply to a previous indication 310. In the exemplary embodiment according to the invention, not all the indications 310 and requests 304 are associated with corresponding responses 312 or confirmations 306. The requirement for a reply depends on the definition of the primitives being exchanged between client 300 and service 302. A reject (REJ) 308 may be sent by either client 300 or service 302 to indicate that a REQ 304 or IND 310 has not been accepted. REJ 308 is essentially a negative reply to a REQ 304 or IND 310.

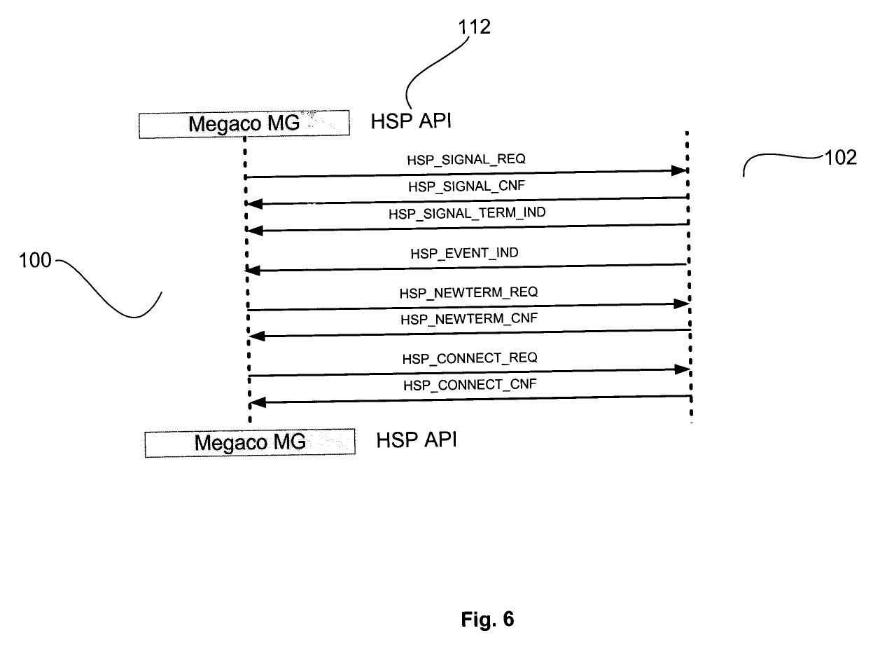

FIG. 6 shows a diagram of an exemplary flow of messages exchanged between the MEGACO stack 100 and the HSP 102. The messages are mediated by HSP API 112, and follow the client-service sequence described with reference to FIG. 4. The messages generally contain primitives in the form of REQ, CNF/REJ pairs or IND, RSP pairs, as described above. However, the sequence of messages may be different, since the order and number of primitives in a call is specific to the hardware being used. In this example, the primitives include a prefix “HSP” indicating the message is traveling through the HSP API 112. As shown in FIG. 2, a delivery agent 122 such as the one described above facilitates the exchange of messages between HSP API 112 and HSP 102.

In the exemplary pairing described, the connection with HSP 102 through HSP API 112 begins when MEGACO stack 100 registers for the service, for example by calling a client addition function of the DA 122 such as “DaAddClient( )”, which tells DA 122 that a new client for the services of HSP 102 is to be added. In response to that function, a message is sent back either confirming registration of the MEGACO stack 100 with HSP 102, or indicating that the request to register has been rejected. HSP API 112 provides several modes of interface to support the exchange of messages. For example, the above mentioned interface for registering the MEGACO stack 100 with the HSP 102 may be provided. In addition, an interface for the exchange of signals, events, statistics and properties, may be provided, as well as an interface for the creation and deletion of terminations such as T1 lines, RTP ports, ATM VC's, AAL2 CID's, etc. Also, HSP API 112 may provide an interface for connection creation and deletion, such as for connecting endpoints in a call. In one example, the client add function may specify a binding identifier used to identify the binding being formed, a module identifier for the requested service, and a module identifier of the client requesting the service.

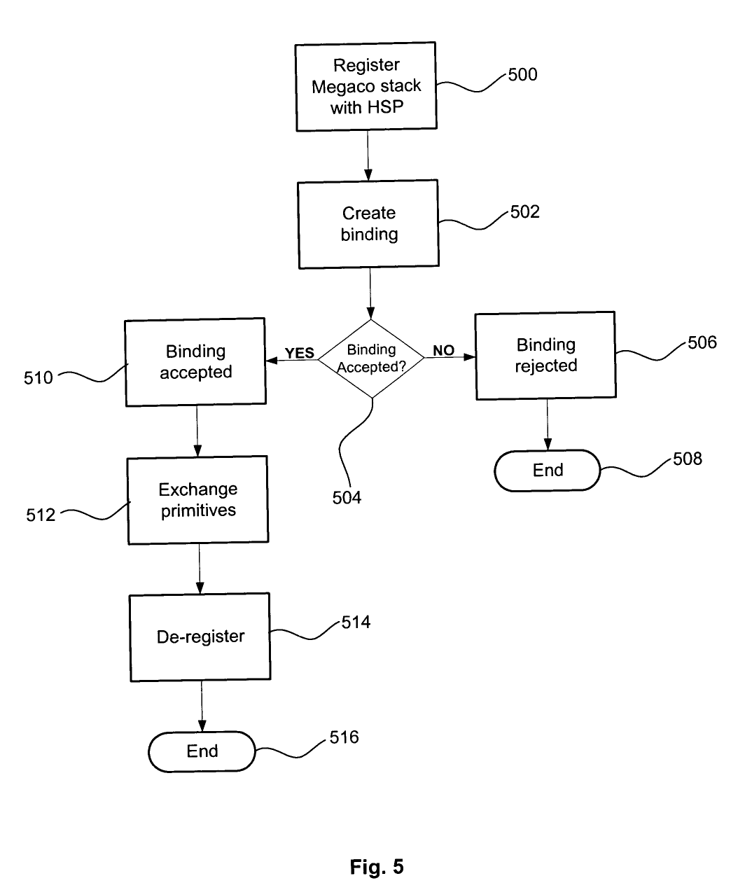

A flowchart depicting an exemplary sequence for a data exchange through HSP API 112 is shown in FIG. 5. Step 500 represents the registration step described above, in which the MEGACO stack 100 registers with HSP 102 to receive its services. As noted, the registration may be carried out via a DaAddClient( ) function sent through the DA 122. The binding between the MEGACO stack 100 and the HSP 102 begins in step 502, such that a client-service relationship is defined. The client-service binding is necessary to permit exchange of primitives between the two parties. However, the binding is not complete until a confirmation or a rejection of the binding is received, in response to the DaAddClient( ) function call.

In one exemplary embodiment, a signal such as the primitive DA_ADDCLIENT_CNF may be received in step 504 through DA 122, indicating that HSP 102 has acknowledged MEGACO stack 100 as a client. Alternatively, another primitive such as DA_ADDCLIENT_REJ may be sent by HSP 102 through DA 122, indicating that the request to register was rejected. The rejection is processed in step 506, and may lead to termination of the registration in step 508. In cases where the registration is accepted, the registration process creates a service access point (SAP) in step 510, to represent the binding. The SAP is a collection of information that identifies the binding and allows software modules to easily distinguish between different bindings.

After the binding is completed and the SAP has been established, the exchange of primitives may begin between client and service (step 512). In one exemplary embodiment, separate functions may be used to send and to receive primitives across the interface defined by DA 122. For example, a primitive structure generated by HSP 102 may be passed across the HSI API 112 as a parameter of a function. The parameter may be set to point, for example, to an HSP 102 structure that includes the primitive's ID as the first element. A second function may be used to receive primitives. For example, a callback function may be used by the MEGACO stack 100 to receive primitives from the HSP 102 via DA 122. In one example, the second function may be passed to DA 122 as an argument of the DaAddClient( ) function described above, used to register the MEGACO stack 100 with the HSP 102. After the exchange of primitives is completed, MEGACO stack 100 may de-register from the binding with HSP 102 in step 514. Once de-registration is complete, the process may end in step 516, or a new binding may take place.

Many different types of primitives may be exchanged in the binding described above, through the primitive send and receive functions that cross HSP API 112. For example, command primitives may be exchanged, which relate to the availability for release of a requested resource, indicate whether an event occurred in the hardware, the status of a signal, and the reservation status of a requested resource, among others. Other classes of primitives may be used in the processes for the addition and deletion of terminations. These primitives may operate on permanent and ephemeral terminations. In the case of permanent terminations, HSP 102 may indicate new terminations or may remove existing terminations. In the case of ephemeral terminations, the MEGACO stack 100 may request HSP 102 to create terminations such as RTP ports, AAL2 CID's, etc.

Another class of primitives may include the HSP connection primitives, which are used to connect two or more streams within a termination. Streams are media flows between potentially different terminations, and there may be several streams within one termination. Primitives of this class may also be used to disconnect streams, and to provide for resource de-allocation. Yet another class of primitives may include HSP error codes. These primitives, as the name implies, are used to indicate errors or failures in the data transfer, such as general errors, invalid parameters or cancellation of operations.

Although the invention was described with reference to specific exemplary embodiments, the same system can be applied with minimal changes to other protocols. The specification and drawings are thus to be regarded as being illustrative rather than restrictive. It will be apparent to those skilled in the art that various modifications and variations can be made in the structure and the methodology of the present invention, without departing from the spirit or scope of the invention. Thus, it is intended that the present invention cover the modifications and variations of this invention provided they come within the scope of the appended claims and their equivalents.

What is claimed is:

1. A system comprising:
a hardware service provider of a media gateway unit;
a media gateway software component of the media gateway unit; and
a program interface element configured to form a connection between the hardware service provider and the media gateway software component, and to exchange data through the connection between different protocol layers.

2. The system according to claim 1, further comprising a delivery agent configured to provide commonality between the protocol layers of the hardware service provider and of the program interface element.

3. The system according to claim 1, wherein the program interface element is configured to register as a client to services provided by the hardware service provider.

4. The system according to claim 1, wherein the program interface element is configured to exchange at least one of signals, events, statistics and properties between the hardware service provider and the media gateway software component.

5. The system according to claim 1, wherein the program interface element is configured to convey commands to create and delete at least one of connections and terminations in the hardware service provider.

6. The system according to claim 2, wherein the delivery agent is configured to exchange data in the form of primitives.

7. The system according to claim 1, wherein the program interface element is configured to initiate a binding between the hardware service provider and the media gateway software component by sending a client addition function to the hardware service provider.

8. The system according to claim 7, wherein the program interface element is configured to receive one of a binding confirmation and a binding rejection signal from the hardware service provider.

9. The system according to claim 2, wherein the program interface element is configured to send signals to the delivery agent to form a service access point describing a binding between the hardware service provider and the media gateway software component.

10. The system according to claim 1, wherein the program interface element is configured to exchange primitives using primitive transfer functions.

11. The system according to claim 10, wherein the primitive transfer functions include separate primitive send and primitive receive functions.

12. A method of interfacing a media gateway software element with a hardware service provider, comprising:
sending from a program interface element of the media gateway software element a client add function, the client add function requesting a binding with the hardware service provider;
receiving in the program interface element a signal indicating acceptance or rejection of the binding;
when the acceptance signal is received, exchanging primitives between the program interface element and the hardware service provider.

13. The method according to claim 12, further comprising sending a request from the program interface element to form a client-service pairing between the hardware service provider and the media gateway software element.

14. The method according to claim 12, further comprising sending from the program interface element at least one of a primitive send and a primitive receive function.

15. The method according to claim 12, wherein the client add function includes at least one of an identifier of the binding, an identifier of a requested service, and an identifier of the media gateway software element.

16. The method according to claim 12, further comprising sending from the program interface element at least one of command primitives, connection primitives, termination addition/deletion primitives and error code primitives.

17. The method according to claim 12, further comprising receiving in the program interface element at least one of command primitives, connection primitives, termination addition/deletion primitives and error code primitives.

18. The method according to claim 12, further comprising exchanging primitives between the program interface element and the hardware service provider with a delivery agent as intermediary, the delivery agent providing the primitives used to pass information between different protocols.

19. The method according to claim 12, further comprising:
sending from the program interface element a function to a delivery agent, the function requesting the delivery agent to initiate a binding with the hardware service provider;
receiving in the program interface element a function from the delivery agent indicating acceptance of the binding by the hardware service provider;
sending from the program interface element a primitive send function to the delivery agent; and
receiving in the program interface element a primitive receive function from the delivery agent.

20. A system comprising:
a program interface element of a media gateway software component; and
a delivery agent communicatively coupled with the program interface element and with a hardware service provider,
wherein the program interface element is configured to initiate with the delivery agent a client/service binding between the hardware service provider and the media gateway software component.

21. The system according to claim 20, wherein the program interface element is configured to send to the delivery agent a client add function to request the binding.

22. The system according to claim 20, wherein the program interface element is configured to receive from the delivery agent one of a binding confirmation and a binding rejection.

23. The system according to claim 20, wherein the program interface element is configured to send to the delivery agent primitive send functions and primitive receive functions.

24. The system according to claim 23, wherein the primitive send functions and primitive receive functions contain as arguments primitives useable by the hardware service provider.

25. The system according to claim 24, wherein the primitives include at least one of command primitives, termination addition/deletion primitives, connection primitives and error code primitives.

26. The system according to claim 21, wherein the client add function includes at least one of a binding identifier, a requested service identifier, and a requesting client identifier.

27. The system according to claim 23, wherein the primitive send functions specify at least one of a binding identifier, a primitive type indicator and a pointer to a primitive data buffer.

28. The system according to claim 23, wherein the primitive receive functions specify at least one of a binding identifier, a primitive type indicator and a pointer to a primitive data buffer.
